(19) United States
(12) Patent Application Publication
(10) Pub. No.: US 2026/0261392 A1
(43) Pub. Date: Sep. 3, 2026

(54) NETWORK-CONTROLLED USER EQUIPMENT-INITIATED CELL ACTIVATION

(71) Applicant: Nokia Technologies Oy, Espoo (FI)

(72) Inventors: Claudio ROSA, Randers NV (DK); Benoist Pierre SEBIRE, Tokyo (JP)

(21) Appl. No.: 19/165,454

(22) PCT Filed: Mar. 24, 2023
(86) PCT No.: PCT/US2023/016318

§ 371 Date: Sep. 15, 2025

(51) Int. Cl. H04L 5/00

(52) U.S. Cl. CPC H04L 5/0098

(57) ABSTRACT

Systems, methods, apparatuses, and computer program products for network-controlled user equipment-initiated (UE-initiated) cell activation. A method may include receiving, from a network element, configuration for user equipment-initiated cell activation, wherein the configuration comprises at least one triggering condition. The method may also include, upon one of the at least one trigger condition being satisfied, triggering transmission of a buffer status report, a power headroom report, or a user equipment-initiated cell activation message, and performing cell activation based on the configuration. The method may further include transmitting a cell activation confirmation message on the activated cell to the network element when the cell is activated and ready for use.

### FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to apparatuses, systems, and/or methods for network-controlled user equipment-initiated (UE-initiated) cell activation.

### BACKGROUND

Examples of mobile or wireless telecommunication systems may include the Universal Mobile Telecommunications System (UMTS) Terrestrial Radio Access Network (UTRAN), LTE Evolved UTRAN (E-UTRAN), LTE-Advanced (LTE-A), MulteFire, LTE-A Pro, fifth generation (5G) radio access technology or NR access technology, and/or 5G-Advanced. 5G wireless systems refer to the next generation (NG) of radio systems and network architecture. 5G network technology is mostly based on NR technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the IoT.

### SUMMARY

Some example embodiments may be directed to a method. The method may include receiving, from a network element, configuration for user equipment-initiated cell activation, wherein the configuration comprises at least one triggering condition. The method may also include, upon one of the at least one trigger condition being satisfied triggering transmission of a buffer status report, a power headroom report, or a user equipment-initiated cell activation message, and performing cell activation based on the configuration. The method may further include transmitting a cell activation confirmation message on the activated cell to the network element when the cell is activated and ready for use.

Other example embodiments may be directed to an apparatus. The apparatus may include at least one processor and at least one memory including computer program code. The at least one memory and computer program code may be configured to, with the at least one processor, cause the apparatus at least to receive, from a network element, configuration for user equipment-initiated cell activation, wherein the configuration comprises at least one triggering condition. The apparatus may also be caused to, upon one of the at least one trigger condition being satisfied, trigger transmission of a buffer status report, a power headroom report, or a user equipment-initiated cell activation message, and perform cell activation based on the configuration. The apparatus may further be caused to transmit a cell activation confirmation message on the activated cell to the network element when the cell is activated and ready for use.

Other example embodiments may be directed to an apparatus. The apparatus may include means for receiving, from a network element, configuration for user equipment-initiated cell activation, wherein the configuration comprises at least one triggering condition. The apparatus may also include means for, upon one of the at least one trigger condition being satisfied triggering transmission of a buffer status report, a power headroom report, or a user equipment-initiated cell activation message, and performing cell activation based on the configuration. The apparatus may further include means for transmitting a cell activation confirmation message on the activated cell to the network element when the cell is activated and ready for use.

In accordance with other example embodiments, a non-transitory computer readable medium may be encoded with instructions that may, when executed in hardware, perform a method. The method may include receiving, from a network element, configuration for user equipment-initiated cell activation, wherein the configuration comprises at least one triggering condition. The method may also include, upon one of the at least one trigger condition being satisfied triggering transmission of a buffer status report, a power headroom report, or a user equipment-initiated cell activation message, and performing cell activation based on the configuration. The method may further include transmitting a cell activation confirmation message on the activated cell to the network element when the cell is activated and ready for use.

Other example embodiments may be directed to a computer program product that performs a method. The method may include receiving, from a network element, configuration for user equipment-initiated cell activation, wherein the configuration comprises at least one triggering condition. The method may also include, upon one of the at least one trigger condition being satisfied triggering transmission of a buffer status report, a power headroom report, or a user equipment-initiated cell activation message, and performing cell activation based on the configuration. The method may further include transmitting a cell activation confirmation message on the activated cell to the network element when the cell is activated and ready for use.

Other example embodiments may be directed to an apparatus that may include circuitry configured to receive, from a network element, configuration for user equipment-initiated cell activation, wherein the configuration comprises at least one triggering condition. The apparatus may also include circuitry configured to, upon one of the at least one trigger condition being satisfied, trigger transmission of a buffer status report, a power headroom report, or a user equipment-initiated cell activation message, and perform cell activation based on the configuration. The apparatus may further include circuitry configured to transmit a cell activation confirmation message on the activated cell to the network element when the cell is activated and ready for use.

Some example embodiments may be directed to a method. The method may include configuring a user equipment for user-equipment initiated cell activation, wherein the configuration comprises at least one triggering condition. The method may also include receiving, from the user equipment based on the configuration, a buffer status report, a power headroom report, or a user equipment-initiated cell activation message on an activated cell. The method may further include monitoring user equipment transmissions on at least one configured uplink resource on the activated cell. In addition, the method may include scheduling the user equipment on the activated cell when a cell activation confirmation message has been received.

Other example embodiments may be directed to an apparatus. The apparatus may include at least one processor and at least one memory including computer program code. The at least one memory and computer program code may be configured to, with the at least one processor, cause the apparatus at least to configure a user equipment for user-equipment initiated cell activation, wherein the configuration comprises at least one triggering condition. The apparatus may also be caused to receive, from the user equipment based on the configuration, a buffer status report, a power headroom report, or a user equipment-initiated cell activation message on an activated cell. The apparatus may further be caused to monitor user equipment transmissions on at least one configured uplink resource on the activated cell. In addition, the apparatus may be caused to schedule the user equipment on the activated cell when a cell activation confirmation message has been received.

Other example embodiments may be directed to an apparatus. The apparatus may include means for configuring a user equipment for user-equipment initiated cell activation, wherein the configuration comprises at least one triggering condition. The apparatus may also include means for receiving, from the user equipment based on the configuration, a buffer status report, a power headroom report, or a user equipment-initiated cell activation message on an activated cell. The apparatus may further include means for monitoring user equipment transmissions on at least one configured uplink resource on the activated cell. In addition, the apparatus may include means for scheduling the user equipment on the activated cell when a cell activation confirmation message has been received.

In accordance with other example embodiments, a non-transitory computer readable medium may be encoded with instructions that may, when executed in hardware, perform a method. The method may include configuring a user equipment for user-equipment initiated cell activation, wherein the configuration comprises at least one triggering condition. The method may also include receiving, from the user equipment based on the configuration, a buffer status report, a power headroom report, or a user equipment-initiated cell activation message on an activated cell. The method may further include monitoring user equipment transmissions on at least one configured uplink resource on the activated cell. In addition, the method may include scheduling the user equipment on the activated cell when a cell activation confirmation message has been received.

Other example embodiments may be directed to a computer program product that performs a method. The method may include configuring a user equipment for user-equipment initiated cell activation, wherein the configuration comprises at least one triggering condition. The method may also include receiving, from the user equipment based on the configuration, a buffer status report, a power headroom report, or a user equipment-initiated cell activation message on an activated cell. The method may further include monitoring user equipment transmissions on at least one configured uplink resource on the activated cell. In addition, the method may include scheduling the user equipment on the activated cell when a cell activation confirmation message has been received.

Other example embodiments may be directed to an apparatus that may include circuitry configured to configure a user equipment for user-equipment initiated cell activation, wherein the configuration comprises at least one triggering condition. The apparatus may also include circuitry configured to receive, from the user equipment based on the configuration, a buffer status report, a power headroom report, or a user equipment-initiated cell activation message on an activated cell. The apparatus may further include circuitry configured to monitor user equipment transmissions on at least one configured uplink resource on the activated cell. In addition, the apparatus may include circuitry configured to schedule the user equipment on the activated cell when a cell activation confirmation message has been received.

### BRIEF DESCRIPTION OF THE DRAWINGS

For proper understanding of example embodiments, reference should be made to the accompanying drawings, wherein:

FIG. 1 illustrates an example flow diagram, according to certain example embodiments.

FIG. 2 illustrates another example flow diagram, according to certain example embodiments.

FIG. 3 illustrates an example flow diagram of a method, according to certain example embodiments.

FIG. 4 illustrates an example flow diagram of another method, according to certain example embodiments.

FIG. 5 illustrates a set of apparatuses, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for network-controlled user equipment-initiated (UE-initiated) cell activation.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “base station”, “cell”, “node”, “gNB”, “network” or other similar language throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

In extended reality (XR) applications, high data rates and low user equipment (UE) power consumption may be required. However, simultaneously fulfilling these requirements may be challenging. Carrier aggregation (CA) with optimized secondary cell (SCell) activation/deactivation based on instantaneous channel and traffic conditions may provide a beneficial trade-off between high data rate and low UE power consumption requirements.

SCell activation delay is a problem limiting the practical applicability of fast and dynamic SCell activation/deactivation. SCell activation may also take up to several tens or even hundreds of milliseconds. In terms of delay, SCell activation delay may include a combination of one or more delay components such as, for example, delay associated with the gNB acquiring the necessary measurement reports that are needed to trigger configuration (and activation) of SCells. Another delay component may include delay associated with the need for the UE to perform automatic gain control (AGC) tuning and time/frequency synchronization after receiving an activation command from the gNB, and before the UE can start operation on the corresponding SCell. Another delay component may include a situation where, when SCell activation is triggered by uplink (UL) traffic, the delay may be associated with the UE sending a buffer status report (BSR) to the gNB.

Specifications of the 3rd Generation Partnership Project (3GPP) have described fast (er) SCell activation since Long Term Evolution (LTE) CA was introduced in the 3GPP specifications. Solutions based on early measurements have been introduced for LTE in Rel-15 (e.g., enhanced utilization of CA) and for NR in Rel-16 dual connectivity and carrier aggregation (DCCA) enhancements, with the goal of reducing the overall SCell activation delay when, for example, a UE transitions from radio resource control (RRC) idle mode to RRC connected mode. However, these solutions focused on reducing the delay associated with the UE performing measurements, and transmitting the corresponding measurement reports necessary for the gNB to initiate SCell configuration and activation when, for example, the UE transitions from RRC idle mode to RRC connected mode.

Although the specifications of 3GPP described some solutions, the solutions do not target the reduction of the delay between the time the UE receives an SCell activation command from the gNB, and the time the UE can initiate operation on the corresponding SCell. The latter problem has been addressed by 3GPP in Rel-17. When sending the SCell activation command, the gNB also provides information on an RRC configured tracking reference signal (TRS) that the UE may use for AGC tuning and time/frequency synchronization. In this way, the SCell activation delay may be reduced since the UE does not need to only rely on synchronization signal blocks (SSBs) for AGC tuning and time/frequency synchronization.

On the other hand, Rel-17 fast SCell activation does not reduce the delay associated with BSR transmission when SCell activation is triggered by UL data arriving in the UE buffer. Additionally, solutions to speed up the SCell activation when triggered by data arrival in the UE buffer have been described. However, such solutions are limited in that activation is exclusively based on buffer status being transmitted and received. Whenever autonomous activation is considered, there is no mention on whether the UE should consider Tx (transmit) power limitations when triggering secondary cell group (SCG)/SCell activation. Furthermore, even if it is referred to as autonomous SCG activation, the conventional solution may relate to the UE autonomously triggering a transmission to the network (e.g., random access channel (RACH), physical uplink control channel (PUCCH)) to request SCG activation. SCell activation in the UE may still be triggered by an activation or confirmation message transmitted by the network (NW). Currently, there is no solution where the UE can initiate SCell activation prior to receiving such activation or confirmation message from the NW. Additionally, even if UE-initiated SCell activation is provided, such a solution does not cover aspects related to triggering based on data in the UE buffer and/or available UL Tx power. In view of the above-described drawbacks, as described herein, certain example embodiments may reduce SCell activation delays when SCell activation is triggered by UL data arriving in the UE buffer.

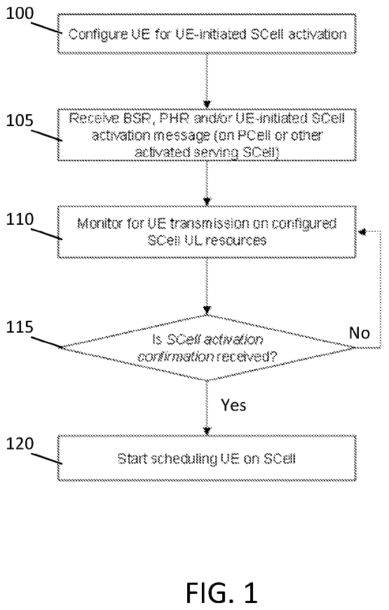

FIG. 1 illustrates an example flow diagram of gNB operations, according to certain example embodiments. As illustrated in FIG. 1, at 100, the gNB may configure the UE for UE-initiated SCell activation. In certain example embodiments, the configuration may include at least one of triggering conditions, SCell UL resources for transmission of an SCell activation conformation, and/or an indication of reference signals to be used for UE-initiated SCell activation. Once the UE has been configured, at 105, the gNB may receive at least one of a BSR, a power headroom report (PHR), and/or a UE-initiated SCell activation message on a primary cell (PCell) (or other activated serving SCell). At 110, the gNB may monitor for UE transmissions on the configured SCell UL resources. At 115, when UE transmission on the configured SCell UL resources is present, the gNB may receive an SCell activation confirmation message on SCell UL resources configured by the gNB. The SCell activation confirmation message can be signaled either explicitly or implicitly. In case of implicit signaling, the UE transmitting on SCell UL resources configured by the gNB is an implicit indication of SCell activation confirmation. After the SCell activation confirmation message has been received, the gNB may, at 120, start scheduling the UE on the SCell. However, if at 115 it is determined that the SCell activation conformation message has not been received, the gNB may continue to monitor for UE transmission on the configured SCell UL resource(s).

According to certain example embodiments, the triggering conditions that the gNB may configure the UE with may include at least one or a combination of the various conditions described herein. For instance, the triggering condition may include the UE buffer status being greater than a predefined BSR threshold (e.g., BSR_Threshold). The triggering condition may also include a UE buffer status having rapidly increased. In certain example embodiments, the rapid increase of the UE buffer status may be assessed by measuring how much data has accumulated in the buffer since the last BSR was sent, or during a specified/configured time window (whose length may be configured). Also, the triggering condition may consider the importance of the PDU set(s) awaiting transmission, for instance by signaling an importance threshold for a logical channel (LCH) or a logical channel group (LCG) below which any changes in the buffer status of the LCH or the LCG are ignored. Further, the triggering condition may include a UE path loss (PL) being smaller (i.e., less) than a predefined PL threshold (e.g., PL_Threshold). In addition, the triggering condition may include a UE PHR being greater than a predefined power headroom (PH) threshold (e.g., PH_Threshold).

In certain example embodiments, using the PH instead of PL to determine when SCell activation should be trigger may be used, for example, when there is dynamic power sharing between already activated cells and the SCell being activated. Although with semi-static power sharing the available power on the SCell being activated may be known at the gNB (hence SCell activation may be based on PL), with dynamic power sharing the available power may depend on the PH available when considering transmission on the already activated cells.

According to further example embodiments, the trigger condition may include a situation when the time to the next periodic BSR is greater than a predefined BSR time threshold (e.g., TimetoBSR Threshold). In certain example embodiments, the time to the next periodic BSR may address a possible NW behavior where the UE is regularly given resources to send a periodic BSR for the gNB to take a scheduling decision (increase or decrease the resources).

In some example embodiments, the buffer status triggers (e.g., triggering conditions of the BSR) may consider a subset of the LCHs and/or a subset of LCGs. In other example embodiments, the subset of LCHs may be configured explicitly or implicitly by signaling a priority below which changes in the corresponding LCHs are ignored.

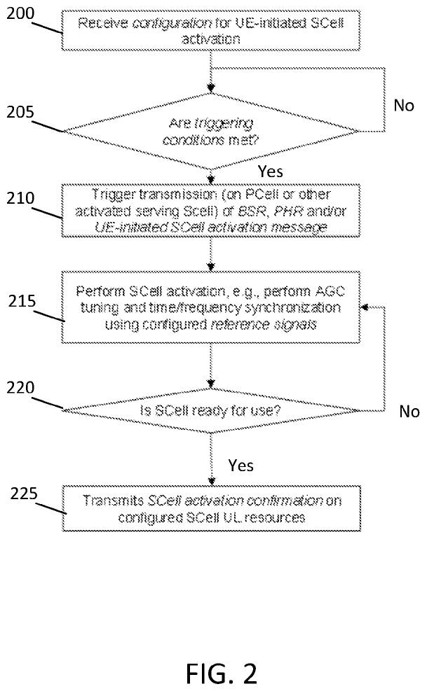

FIG. 2 illustrates an example flow diagram of UE operations, according to certain example embodiments. As illustrated in FIG. 2, at 200, the UE may receive a configuration from the gNB for UE-initiated SCell activation. In certain example embodiments, the configuration may include any one or a combination of triggering conditions described above. At 205, the UE may determine whether any one or a combination of the triggering conditions have been met. If no, the UE may continue to monitor/determine whether any of the triggering conditions have been met. When one or a combination of the triggering conditions have been met, at 210, the UE may trigger transmission (on the PCell or other activated serving SCell) of the BSR, PHR, and/or UE-initiated SCell activation message on the PCell. At 215, when one or a combination of triggering conditions has been met, the UE may start SCell activation, which may include, for example, performing AGC tuning and time/frequency synchronization using the reference signals indicated by the gNB for UE-initiated SCell activation. These may be the reference signals (DL) that the UE uses to perform AGC tuning and time/frequency synchronization while activating the SCell.

At 220, the UE may determine whether the SCell is ready for use. If the SCell is not ready for use, the procedure may return to 215 to perform SCell activation. If it is determined that the SCell is ready for use, the UE may be ready to transmit/receive on the activated SCell. The UE may also, at 225, transmit an SCell activation confirmation message to the gNB on the configured SCell UL resources. In certain example embodiments, SCell UL resources may correspond to the resources the UE uses to transmit SCell activation conformation when the SCell is finally activated.

In certain example embodiments, the UE-initiated SCell activation may be configured as part of the SCell configuration (RRC). In other example embodiments, the UE-initiated SCell activation message may be a new medium access control control element (MAC CE) transmitted from the UE to the gNB. In further example embodiments, if the configuration from the gNB includes an indication to use specified reference signals other than a SSB (e.g., TRS) for UE-initiated SCell activation, the UE may use SSB for AGC and frequency/time synchronization prior to transmission of the BRS, PHR, and/or UE-initiated SCell activation message (or positive acknowledgment of the reception of the transport block including the BSR, PHR, and/or UE-initiated SCell activation message), and reference signals other than SSB (e.g., TRS) for AGC and frequency/time synchronization after transmission of the BSR, PHR, and/or UE-initiated SCell activation message (or positive acknowledgment of the reception of the transport block including the BSR, PHR, and/or UE-initiated SCell activation message). In certain example embodiments, the UE may assume one RS configuration before transmission of the SCell activation message, and another RS configuration after transmission of the SCell activation message.

According to certain example embodiments, the SCell being activated may use a same timing advance (TA) as at least another already activated cell (e.g., the PCell). In this case, the UL resources configured for transmitting the SCell activation conformation message may be configured grant (CG) physical uplink shared channel (PUSCH) Type 1 resources. According to other example embodiments, the UL resources may be sounding reference signal (SRS) resources, or PUCCH resources.

In certain example embodiments, the validity of the UL resources allocated in the UL-initiated SCell activation message for the transmission of the SCell activation confirmation may be valid for a predefined limited time or number of occasions after transmission of the SCell activation confirmation. For instance, in certain example embodiments, the resources may be automatically deactivated after being used for transmitting the SCell activation conformation.

In further example embodiments, the SCell being activated may use a different TA than other already activated cells (e.g. the PCell). In this example, the UL resources configured for transmitting the SCell activation conformation may be physical random access channel (PRACH) resources. Furthermore, in other example embodiments, a two-step random access channel (RACH) procedure may be implemented to send the SCell activation confirmation as well as BSR and/or PHR.

According to certain example embodiments, at least one of the conditions to trigger SCell activation may include an increase of the amount of data in the UE buffer by more than X bytes or more than Y % within a specified time window T, where X, Y, and T may be parameters configured by the NW via, for example, RRC signaling. Additionally, the UE buffer may not be considered as a whole, and instead be considered as a subset of the LCHs and/or subset of the LCGs selected for the triggering conditions. According to some example embodiments, the selection of the subset of the LCHs and/or LGCs may be based on signaling from the network (e.g., gNB). For example, the gNB may configure the subset of LCHs and/or LGCs explicitly or implicitly, and/or the gNB may signal a LCH priority threshold. In certain example embodiments, the LCHs whose priority is equal to or greater than (≥), or greater than (>) the LCH priority threshold may be considered.

In certain example embodiments, the signaling from the gNB of the selection of the LCHs and/or LCGs may be made per SCell. Additionally, the subset of LHCs may be implicitly derived from mapping restrictions of the SCell to be activated. That is, the buffer status of the LCHs whose logical channel priority (LCP) mapping restrictions forbid the LCH to be transmitted on the SCell may be excluded.

According to other example embodiments, at least one of the conditions to trigger SCell activation may be that the PH is greater than a specific threshold PH_Threshold. In this example, the UE may calculate the available PH based on Type 1 PH calculated for each of the activated cells within a group of cells (e.g., master cell group (MCG)). For instance, in certain example embodiments, the nominal UE maximum transmit power may be assumed to be P_{NOM} dBm. If the UE has only one activated cell within the corresponding cell group and the PH for the corresponding cell is calculated as X dB, then the available PH may be determined as (P_{NOM}−X) dB. In other example embodiments, if the UE has two activated cells within the corresponding cell group and the PH for the corresponding cells are calculated as X₁ and X₂ dB, respectively, then the available PH may be determined as

$$10 * {log}_{10} ( 1 {0}^{\frac{{P}_{N O M} - {X}_{1}}{10}} + 1 {0}^{\frac{{P}_{NOM} - {X}_{2}}{10}} ) .$$

More generally, if the UE has N activated cells within the corresponding cell group and the PH for the corresponding cells are calculated as X₁, X₂, . . . . X_{N} dB, respectively, then the available PH may be determined as

$$10 * {log}_{10} ( {\sum }_{i = 1}^{N} 1 {0}^{\frac{{P}_{N O M} - {X}_{i}}{10}} ) .$$

Additionally, the UE may determine whether the PH for an activated serving cell is based on an actual transmission or based on a reference format based on higher layer signaling.

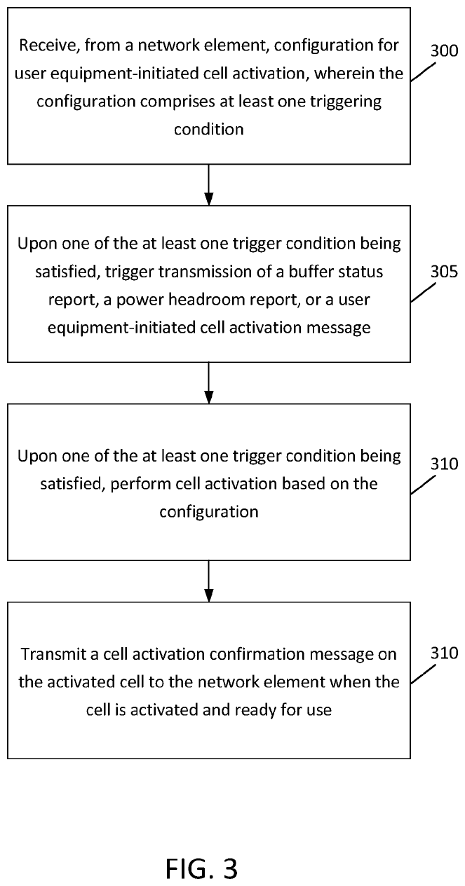

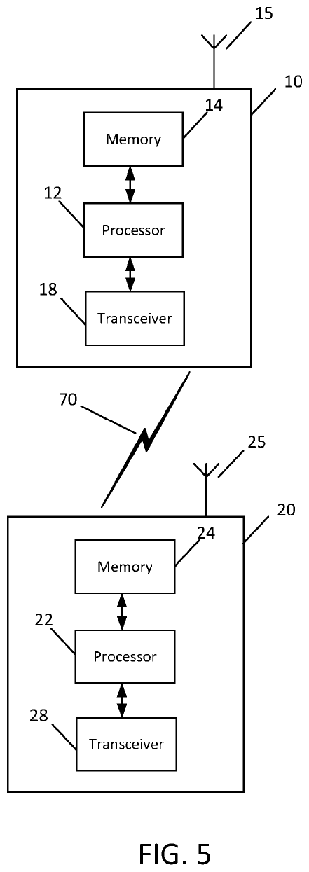

FIG. 3 illustrates an example flow diagram of a method, according to certain example embodiments. In an example embodiment, the method of FIG. 3 may be performed by a network entity, or a group of multiple network elements in a 3GPP system, such as LTE or 5G-NR. For instance, in an example embodiment, the method of FIG. 3 may be performed by a UE similar to one of apparatuses 10 or 20 illustrated in FIG. 5.

According to certain example embodiments, the method of FIG. 3 may include, at 300, receiving, from a network element, configuration for user equipment-initiated cell activation. According to certain example embodiments, the configuration may include at least one triggering condition. The method may also include, at 305, upon one of the at least one trigger condition being satisfied, triggering transmission of a buffer status report, a power headroom report, or a user equipment-initiated cell activation message. The method may further include, at 310, upon one of the at least one trigger condition being satisfied, performing cell activation based on the configuration. In addition, the method may include, at 315, transmitting a cell activation confirmation message on the activated cell to the network element when the cell is activated and ready for use.

According to certain example embodiments, the configuration may further include at least one cell uplink resource for the transmission of the cell activation confirmation message, and at least one indication of at least one reference signal to be used for the user equipment-initiated cell activation. According to some example embodiments, the cell activation confirmation message may be transmitted on configured grant uplink resources configured by the network element. According to further example embodiments, activation of the cell may be implied to the network element when transmission is performed on the at least one uplink resource configured by the network element. According to other example embodiments, the at least one triggering condition may include at least one of a user equipment buffer status being greater than a buffer threshold, an increase of the user equipment buffer status within a specified time window being greater than a buffer threshold, a user equipment buffer status including protocol data unit sets of importance greater than a predefined threshold, a user equipment path loss being less than a predefined path loss threshold, a user equipment power headroom being greater than a predefined power headroom threshold, or a time window to the next periodic buffer status report being greater than a time threshold.

In certain example embodiments, when the configuration includes an indication to use reference signals other than a synchronization signal block for the user equipment-initiated cell activation, the method, the method may further include using the synchronization signal block for automatic gain control and frequency or time synchronization prior to transmission of the buffer status report, the power headroom report, or the UE-initiated cell activation message, and using reference signals other than the synchronization signal block for automatic gain control and frequency or time synchronization after transmission of the buffer status report, the power headroom report, or the user equipment-initiated cell activation message. In some example embodiments, the cell being activated may use a same timing advance as at least another already activated cell. In other example embodiments, the cell being activated may use a different timing advance as the at least another already activated cell.

According to certain example embodiments, the cell activation confirmation message may be transmitted on physical random access resources. According to further example embodiments, the at least one uplink resource may be valid for a predefined amount of time or a predefined number of occasions after transmission of the cell activation confirmation message. According to some example embodiments, a user equipment buffer may be a subset of logical channels or a subset of logical channel groups selected for the at least one triggering condition.

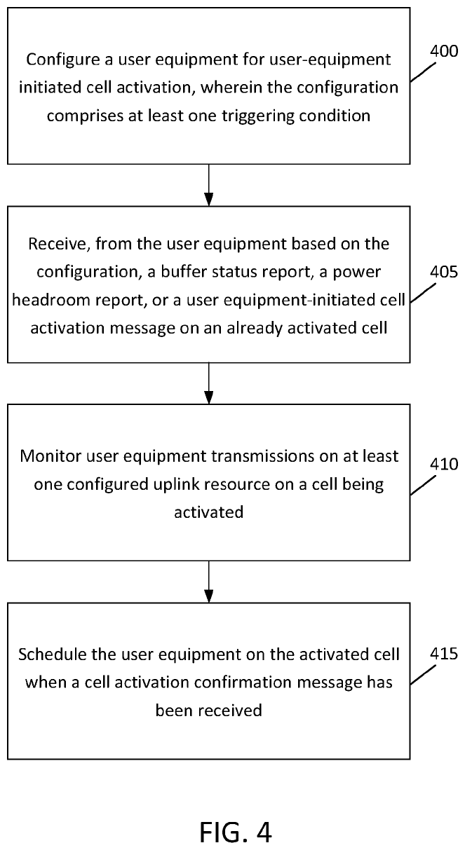

FIG. 4 illustrates an example flow diagram of a method, according to certain example embodiments. In an example embodiment, the method of FIG. 4 may be performed by a network entity, or a group of multiple network elements in a 3GPP system, such as LTE or 5G-NR. For instance, in an example embodiment, the method of FIG. 4 may be performed by a gNB similar to one of apparatuses 10 or 20 illustrated in FIG. 5.

According to certain example embodiments, the method of FIG. 4 may include, at 400, configuring a user equipment for user-equipment initiated cell activation, wherein the configuration comprises at least one triggering condition. The method may also include, at 405, receiving, from the user equipment based on the configuration, a buffer status report, a power headroom report, or a user equipment-initiated cell activation message on an already activated cell. In some example embodiments, the already activated cell may include a PCell. The method may further include, at 410, monitoring user equipment transmissions on at least one configured uplink resource on a cell being activated. In some example embodiments, the cell being activated may include an SCell. In addition, the method may include, at 415, scheduling the user equipment on the activated cell when a cell activation confirmation message has been received.

According to certain example embodiments, the configuration may further include at least one uplink resource for transmission of the cell activation confirmation message, or an indication of at least one reference signal to be used for the user equipment-initiated cell activation. In some example embodiments, the UE may transmit the cell activation conformation message. According to some example embodiments, the cell activation confirmation message may be received on configured grant uplink resources configured by a network element. According to other example embodiments, activation of the cell may be implied when transmission is performed on the at least one uplink resource configured by a network element. According to further example embodiments, the at least one triggering condition may include at least one of a user equipment buffer status being greater than a buffer threshold, an increase of the user equipment buffer status within a specified time window being greater than a buffer threshold, a user equipment buffer status including protocol data unit sets of importance greater than a predefined threshold, a user equipment path loss being less than a predefined path loss threshold, a user equipment power headroom being greater than a predefined power headroom threshold, or a time window to the next periodic buffer status report being greater than a time threshold.

In certain example embodiments, In some example embodiments, the method may also include defining, via radio resource control signaling, an amount of X bytes of data in a user equipment buffer, Y % of the data in the user equipment buffer, and a specified window T. In further example embodiments, the method may also include configuring a subset of logical channels or a subset of logical channel groups in a user equipment buffer, and signaling, to the user equipment, a logical channel priority threshold, and logical channels whose priority is equal to or greater, or greater than the logical channel priority threshold.

FIG. 5 illustrates a set of apparatuses 10 and 20 according to certain example embodiments. In certain example embodiments, the apparatus 10 may be an element in a communications network or associated with such a network, such as a UE, mobile equipment (ME), mobile station, mobile device, stationary device, IoT device, or other device. It should be noted that one of ordinary skill in the art would understand that apparatus 10 may include components or features not shown in FIG. 5.

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 10 may include components or features not shown in FIG. 5.

As illustrated in the example of FIG. 5, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 5, multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes and examples illustrated in FIGS. 1-3.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods and examples illustrated in FIGS. 1-3.

In some example embodiments, apparatus 10 may also include or be coupled to one or more antennas 15 for receiving a downlink signal and for transmitting via an UL from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an UL.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

For instance, in certain example embodiments, apparatus 10 may be controlled by memory 14 and processor 12 to receive, from a network element, configuration for user equipment-initiated cell activation, wherein the configuration comprises at least one triggering condition. Apparatus 10 may also be controlled by memory 14 and processor 12 to, upon one of the at least one trigger condition being satisfied, trigger transmission of a buffer status report, a power headroom report, or a user equipment-initiated cell activation message, and performing cell activation based on the configuration. In addition, apparatus 10 may be controlled by memory 14 and processor 12 to transmit a cell activation confirmation message on the activated cell to the network element when the cell is activated and ready for use.

As illustrated in the example of FIG. 5, apparatus 20 may be a network, core network element, or element in a communications network or associated with such a network, such as a gNB, BS, cell, or NW. It should be noted that one of ordinary skill in the art would understand that apparatus 20 may include components or features not shown in FIG. 5.

In some example embodiments, apparatus 20 may include one or more processors, one or more computer-readable storage medium (for example, memory, storage, or the like), one or more radio access components (for example, a modem, a transceiver, or the like), and/or a user interface. In some example embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 5.

As illustrated in the example of FIG. 5, apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 5, multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes and examples illustrated in FIGS. 1, 2, and 4.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods and examples illustrated in FIGS. 1, 2, and 4.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an UL).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

For instance, in certain example embodiments, apparatus 20 may be controlled by memory 24 and processor 22 to configure a user equipment for user-equipment initiated cell activation, wherein the configuration comprises at least one triggering condition. Apparatus 20 may also be controlled by memory 24 and processor 22 to receive, from the user equipment based on the configuration, a buffer status report, a power headroom report, or a user equipment-initiated cell activation message on an already activated cell. Apparatus 20 may further be controlled by memory 24 and processor 22 to monitor user equipment transmissions on at least one configured uplink resource on a cell being activated. In addition, apparatus 20 may be controlled by memory 24 and processor 22 to schedule the user equipment on the activated cell when a cell activation confirmation message has been received.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for receiving, from a network element, configuration for user equipment-initiated cell activation, wherein the configuration comprises at least one triggering condition. The apparatus may also include means for, upon one of the at least one trigger condition being satisfied, triggering transmission of a buffer status report, a power headroom report, or a user equipment-initiated cell activation message, and performing cell activation based on the configuration. In addition, the apparatus may include means for transmitting a cell activation confirmation message on the activated cell to the network element when the cell is activated and ready for use.

Other example embodiments may be directed to an apparatus that includes means for configuring a user equipment for user-equipment initiated cell activation, wherein the configuration comprises at least one triggering condition. The apparatus may also include means for receiving, from the user equipment based on the configuration, a buffer status report, a power headroom report, or a user equipment-initiated cell activation message on an already activated cell. The apparatus may further include means for monitoring user equipment transmissions on at least one configured uplink resource on a cell being activated. In addition, the apparatus may include means for scheduling the user equipment on the activated cell when a cell activation confirmation message has been received.

Certain example embodiments described herein provide several technical improvements, enhancements, and/or advantages. For instance, in some example embodiments, it may be possible to reduce SCell activation delays as compared to current standardized methods when the SCell activation is triggered by UL data arriving in the UE buffer.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### Partial Glossary

3GPP 3rd Generation Partnership Project
5G 5th Generation
5GCN 5G Core Network
5GS 5G System
AGC Automatic Gain Control
AI/ML Artificial Intelligence/Machine Learning
AMF Access and Mobility Function
AS Access Stratum
BS Base Station
BSR Buffer Status Report
CA Carrier Aggregation
CE Control Element
CG Configured Grant
DC Dual Connectivity
DL Downlink
eNB Enhanced Node B
euCA Enhanced Utilization of Carrier Aggregation
E-UTRAN
gNB
Evolved UTRAN
5G or Next Generation NodeB
HW Hardware
IMSI International Mobile Subscriber Identity
LCG Logical Channel Group
LTE Long Term Evolution
MAC Medium Access Control
MCG Master Cell Group
NAS Non-Access Stratum
NR New Radio
NW Network
PCell Primary Cell
PHR Power Headroom Report
PRACH Physical RACH
PUCCH Physical Uplink Control Channel
PUSCH Physical Uplink Shared Channel
RACH Random Access Channel
RAN Radio Access Network
RAT Radio Access Technology
RF Radio Frequency
RRC Radio Resource Control
SCell Secondary Cell
Secondary Cell Group SCG
SSB Synchronization Signal Block
TA Timing Advance
TRS Tracking Reference Symbol
UE User Equipment
UL Uplink
XR Extended Reality
UP User Plane

We claim:

1. A method, comprising:
receiving, from a network element, configuration for user equipment-initiated cell activation, wherein the configuration comprises at least one triggering condition;
upon one of the at least one trigger condition being satisfied,
triggering transmission of a buffer status report, a power headroom report, or a user equipment-initiated cell activation message, and
performing cell activation based on the configuration; and
transmitting a cell activation confirmation message on the activated cell to the network element when the cell is activated and ready for use.

2. The method according to claim 1, wherein the configuration further comprises at least one of the following:
at least one uplink resource for the transmission of the cell activation confirmation message, or
an indication of at least one reference signal to be used for the user equipment-initiated cell activation.

3. The method according to claim 1 or 2, wherein the cell activation confirmation message is transmitted on configured grant uplink resources configured by the network element.

4. The method according to claim 1 or 2, wherein activation of the cell is implied to the network element when transmission is performed on the at least one uplink resource configured by the network element.

5. The method according to any of claims 1-4, wherein the at least one triggering condition comprises at least one of the following:
a user equipment buffer status being greater than a buffer threshold,
an increase of the user equipment buffer status within a specified time window being greater than a buffer threshold,
a user equipment buffer status comprising protocol data unit sets of importance greater than a threshold,
a user equipment path loss being less than a predefined path loss threshold,
a user equipment power headroom being greater than a predefined power headroom threshold, or
a time window to a next periodic buffer status report being greater than a time threshold.

6. The method according to any of claims 1-5, wherein when the configuration comprises an indication to use reference signals other than a synchronization signal block for the user equipment-initiated cell activation, the method further comprises:
using the synchronization signal block for automatic gain control and frequency or time synchronization prior to transmission of the buffer status report, the power headroom report, or the user equipment-initiated cell activation message; and
using reference signals other than the synchronization signal block for automatic gain control and frequency or time synchronization after transmission of the buffer status report, the power headroom report, or the user equipment-initiated cell activation message.

7. The method according to any of claims 1-6, wherein the cell being activated uses a same timing advance as at least another already activated cell.

8. The method according to any of claims 1-6 wherein the cell being activated uses a different timing advance as the at least another already activated cell.

9. The method according to any of claims 1-8, wherein the cell activation confirmation message is transmitted on physical random access resources.

10. The method according to any of claims 1-9, wherein the at least one uplink resource is valid for a predefined amount of time or a predefined number of occasions after transmission of the cell activation confirmation message.

11. The method according to any of claims 1-10, wherein a user equipment buffer is a subset of logical channels or a subset of logical channel groups selected for the at least one triggering condition.

12. A method, comprising:
configuring a user equipment for user-equipment initiated cell activation, wherein the configuration comprises at least one triggering condition;
receiving, from the user equipment based on the configuration, a buffer status report, a power headroom report, or a user equipment-initiated cell activation message on an already activated cell;
monitoring user equipment transmissions on at least one configured uplink resource on a cell being activated; and
scheduling the user equipment on the cell being activated when a cell activation confirmation message has been received.

13. The method according to claim 12, wherein the configuration further comprises at least one of the following:
at least one uplink resource for transmission of the cell activation confirmation message, or
an indication of at least one reference signal to be used for the user equipment-initiated cell activation.

14. The method according to claim 12 or 13, wherein the cell activation confirmation message is received on configured grant uplink resources configured by a network element.

15. The method according to claim 12 or 13, wherein activation of the cell is implied when transmission is performed on the at least one uplink resource configured by a network element.

16. The method according to any of claims 12-15, wherein the at least one triggering condition comprises at least one of the following:
a user equipment buffer status being greater than a buffer threshold,
an increase of the user equipment buffer status within a specified time window being greater than a buffer threshold,
a user equipment buffer status comprising protocol data unit sets of importance greater than a threshold;
a user equipment path loss being less than a predefined path loss threshold,
a user equipment power headroom being greater than a predefined power headroom threshold, or
a time window to a next periodic buffer status report is greater than a time threshold.

17. The method according to any of claims 12-16, further comprising:
defining, via radio resource control signaling, an amount of X bytes of data in a user equipment buffer, Y % of the data in the user equipment buffer, and a specified window T.

18. The method according to any of claims 12-17, further comprising:
configuring a subset of logical channels or a subset of logical channel groups in a user equipment buffer; and
signaling, to the user equipment, a logical channel priority threshold, and logical channels whose priority is equal to or greater, or greater than the logical channel priority threshold.

19. An apparatus, comprising:
at least one processor; and
at least one memory comprising computer program code,
the at least one memory and the computer program code configured to, with storing instructions that, when executed by the at least one processor, cause the apparatus at least to:
receive, from a network element, configuration for user equipment-initiated cell activation, wherein the configuration comprises at least one triggering condition;
upon one of the at least one trigger condition being satisfied,
trigger transmission of a buffer status report, a power headroom report, or a user equipment-initiated cell activation message, and
perform cell activation based on the configuration; and
transmit a cell activation confirmation message on the activated cell to the network element when the cell is activated and ready for use.

20. The apparatus according to claim 19, wherein the configuration further comprises at least one of the following:
at least one uplink resource for the transmission of the cell activation confirmation message, or
an indication of at least one reference signal to be used for the user equipment-initiated cell activation.

21. The apparatus according to claim 19 or 20, wherein the cell activation confirmation message is transmitted on configured grant uplink resources configured by the network element.

22. The apparatus according to claim 19 or 20, wherein activation of the cell is implied to the network element when transmission is performed on the at least one uplink resource configured by the network element.

23. The apparatus according to any of claims 19-22, wherein the at least one triggering condition comprises at least one of the following:
a user equipment buffer status being greater than a buffer threshold,
an increase of the user equipment buffer status within a specified time window being greater than a buffer threshold,
a user equipment buffer status comprising protocol data unit sets of importance greater than a threshold,
a user equipment path loss being less than a predefined path loss threshold,
a user equipment power headroom being greater than a predefined power headroom threshold, or
a time window to a next periodic buffer status report being greater than a time threshold.

24. The apparatus according to any of claims 19-23, wherein when the configuration comprises an indication to use reference signals other than a synchronization signal block for the user equipment-initiated cell activation, the method further comprises:
using the synchronization signal block for automatic gain control and frequency or time synchronization prior to transmission of the buffer status report, the power headroom report, or the user equipment-initiated cell activation message; and
using reference signals other than the synchronization signal block for automatic gain control and frequency or time synchronization after transmission of the buffer status report, the power headroom report, or the user equipment-initiated cell activation message.

25. The apparatus according to any of claims 19-24, wherein the cell being activated uses a same timing advance as at least another already activated cell.

26. The apparatus according to any of claims 19-24 wherein the cell being activated uses a different timing advance as the at least another already activated cell.

27. The apparatus according to any of claims 19-26, wherein the cell activation confirmation message is transmitted on physical random access resources.

28. The apparatus according to any of claims 19-27, wherein the at least one uplink resource is valid for a predefined amount of time or a predefined number of occasions after transmission of the cell activation confirmation message.

29. The apparatus according to any of claims 19-28, wherein a user equipment buffer is a subset of logical channels or a subset of logical channel groups selected for the at least one triggering condition.

30. An apparatus, comprising:
at least one processor; and
at least one memory comprising computer program code,
the at least one memory and the computer program code configured to, with storing instructions that, when executed by the at least one processor, cause the apparatus at least to:
configure a user equipment for user-equipment initiated cell activation, wherein the configuration comprises at least one triggering condition;
receive, from the user equipment based on the configuration, a buffer status report, a power headroom report, or a user equipment-initiated cell activation message on an already activated cell;
monitor user equipment transmissions on at least one configured uplink resource on a cell being activated; and
schedule the user equipment on the activated cell when a cell activation confirmation message has been received.

31. The apparatus according to claim 30, wherein the configuration further comprises at least one of the following:
at least one uplink resource for transmission of the cell activation confirmation message, or
an indication of at least one reference signal to be used for the user equipment-initiated cell activation.

32. The apparatus according to claim 30 or 31 wherein the cell activation confirmation message is received on configured grant uplink resources configured by the apparatus.

33. The apparatus according to claim 30 or 31, wherein activation of the cell is implied when transmission is performed on the at least one uplink resource configured by the apparatus.

34. The apparatus according to any of claims 30-33, wherein the at least one triggering condition comprises at least one of the following:
a user equipment buffer status being greater than a buffer threshold,
an increase of the user equipment buffer status within a specified time window being greater than a buffer threshold,
a user equipment buffer status comprising protocol data unit sets of importance greater than a threshold;
a user equipment path loss being less than a predefined path loss threshold,
a user equipment power headroom being greater than a predefined power headroom threshold, or
a time window to a next periodic buffer status report is greater than a time threshold.

35. The apparatus according to any of claims 30-34, further comprising:
defining, via radio resource control signaling, an amount of X bytes of data in a user equipment buffer, Y % of the data in the user equipment buffer, and a specified window T.

36. The apparatus according to any of claims 30-35, wherein the apparatus is further caused to:
configure a subset of logical channels or a subset of logical channel groups in a user equipment buffer; and
signal, to the user equipment, a logical channel priority threshold, and logical channels whose priority is equal to or greater, or greater than the logical channel priority threshold.

37. An apparatus, comprising:
means for receiving, from a network element, configuration for user equipment-initiated cell activation, wherein the configuration comprises at least one triggering condition;
upon one of the at least one trigger condition being satisfied,
means for triggering transmission of a buffer status report, a power headroom report, or a user equipment-initiated cell activation message, and
means for performing cell activation based on the configuration; and
means for transmitting a cell activation confirmation message on the activated cell to the network element when the cell is activated and ready for use.

38. The apparatus according to claim 37, wherein the configuration further comprises at least one of the following:
at least one uplink resource for the transmission of the cell activation confirmation message, or
an indication of at least one reference signal to be used for the user equipment-initiated cell activation.

39. The apparatus according to claim 37 or 38, wherein the cell activation confirmation message is transmitted on configured grant uplink resources configured by the network element.

40. The apparatus according to claim 37 or 38, wherein activation of the cell is implied to the network element when transmission is performed on the at least one uplink resource configured by the network element.

41. The apparatus according to any of claims 37-40, wherein the at least one triggering condition comprises at least one of the following:
a user equipment buffer status being greater than a buffer threshold,
an increase of the user equipment buffer status within a specified time window being greater than a buffer threshold,
a user equipment buffer status comprising protocol data unit sets of importance greater than a threshold,
a user equipment path loss being less than a predefined path loss threshold,
a user equipment power headroom being greater than a predefined power headroom threshold, or
a time window to a next periodic buffer status report being greater than a time threshold.

42. The apparatus according to any of claims 37-41, wherein when the configuration comprises an indication to use reference signals other than a synchronization signal block for the user equipment-initiated cell activation, the method further comprises:
using the synchronization signal block for automatic gain control and frequency or time synchronization prior to transmission of the buffer status report, the power headroom report, or the user equipment-initiated cell activation message; and
using reference signals other than the synchronization signal block for automatic gain control and frequency or time synchronization after transmission of the buffer status report, the power headroom report, or the user equipment-initiated cell activation message.

43. The apparatus according to any of claims 37-42, wherein the cell being activated uses a same timing advance as at least another already activated cell.

44. The apparatus according to any of claims 37-42 wherein the cell being activated uses a different timing advance as the at least another already activated cell.

45. The apparatus according to any of claims 37-44, wherein the cell activation confirmation message is transmitted on physical random access resources.

46. The apparatus according to any of claims 37-45, wherein the at least one uplink resource is valid for a predefined amount of time or a predefined number of occasions after transmission of the cell activation confirmation message.

47. The apparatus according to any of claims 37-46, wherein a user equipment buffer is a subset of logical channels or a subset of logical channel groups selected for the at least one triggering condition.

48. An apparatus, comprising:
means for configuring a user equipment for user-equipment initiated cell activation, wherein the configuration comprises at least one triggering condition;
means for receiving, from the user equipment based on the configuration, a buffer status report, a power headroom report, or a user equipment-initiated cell activation message on an already activated cell;
means for monitoring user equipment transmissions on at least one configured uplink resource on a cell being activated; and
means for scheduling the user equipment on the activated cell when a cell activation confirmation message has been received.

49. The apparatus according to claim 48, wherein the configuration further comprises at least one of the following:
at least one uplink resource for transmission of the cell activation confirmation message, or
an indication of at least one reference signal to be used for the user equipment-initiated cell activation.

50. The apparatus according to claim 48 or 49, wherein the cell activation confirmation message is received on configured grant uplink resources configured by the apparatus.

51. The apparatus according to claim 48 or 49, wherein activation of the cell is implied when transmission is performed on the at least one uplink resource configured by the apparatus.

52. The apparatus according to any of claims 48-51, wherein the at least one triggering condition comprises at least one of the following:
a user equipment buffer status being greater than a buffer threshold,
an increase of the user equipment buffer status within a specified time window being greater than a buffer threshold,
a user equipment buffer status comprising protocol data unit sets of importance greater than a threshold;
a user equipment path loss being less than a predefined path loss threshold,
a user equipment power headroom being greater than a predefined power headroom threshold, or
a time window to a next periodic buffer status report is greater than a time threshold.

53. The apparatus according to any of claims 48-52, further comprising:
defining, via radio resource control signaling, an amount of X bytes of data in a user equipment buffer, Y % of the data in the user equipment buffer, and a specified window T.

54. The apparatus according to any of claims 48-53, further comprising:
means for configuring a subset of logical channels or a subset of logical channel groups in a user equipment buffer; and
means for signaling, to the user equipment, a logical channel priority threshold, and logical channels whose priority is equal to or greater, or greater than the logical channel priority threshold.

55. A non-transitory computer readable medium comprising program instructions stored thereon for performing the method according to any of claims 1-18.

56. An apparatus comprising circuitry configured to cause the apparatus to perform a process according to any of claims 1-18.
